(19) United States
(12) Patent Application Publication
(10) Pub. No.: US 2024/0017590 A1
(43) Pub. Date: Jan. 18, 2024

(54) System and Method for Monitoring the Interior of a Vehicle

(71) Applicant: Bayerische Motoren Werke Aktiengesellschaft, Muenchen (DE)

(72) Inventors: Marcus REHWINKEL, Muenchen (DE); Johannes WALDTHAUSEN, Penzing (DE)

(21) Appl. No.: 18/026,202

(22) PCT Filed: Aug. 30, 2021
(86) PCT No.: PCT/EP2021/073872

§ 371 Date: Mar. 14, 2023

(30) Foreign Application Priority Data
Sep. 22, 2020 (DE) 10 2020 124 671.4

(51) Int. Cl. B60H 1/00

(52) U.S. Cl. CPC B60H 1/00742; B60H 1/00778; B60H 1/00757; B60H 1/00878; B60H 1/00821

(57) ABSTRACT

A system and method monitor the interior of a vehicle, in particular a parked vehicle. A detection unit is designed to detect a living being in an interior of the vehicle. At least one control unit is designed to actuate at least one vehicle function in order to influence at least one environmental condition in the interior of the vehicle if: the detection unit detects a living being in the interior of the vehicle, and the at least one environmental condition in the interior of the vehicle exceeds or falls below at least one predetermined threshold value; and/or the control unit is designed to actuate at least one vehicle function in order to influence at least one environmental condition in the interior of the vehicle if: the detection unit detects a living being in the interior of the vehicle, and the at least one environmental condition in the interior of the vehicle exhibits a rise or fall.

### BACKGROUND AND SUMMARY

The present disclosure relates to a system for monitoring the interior of a vehicle, to a vehicle having such a system, to a method for monitoring the interior of a vehicle and to a storage medium for executing the method. The present disclosure relates in particular to detecting living beings in an interior of the vehicle, in particular while parked, and to producing a hospitable environment in the interior of the vehicle if it has been detected that the environmental conditions appear to be life-threatening.

Ever more elaborate and more complex electronics are installed in modern vehicles nowadays. This means that an energy demand of the vehicle also increases, which, in particular when the vehicle is stationary for a relatively long time, leads to draining of a corresponding power supply, such as a battery, for example. Minimizing power consumption of the vehicle when it is stationary is therefore often strived for. This is achieved, inter alia, by the so-called idle mode, in which the vehicle or its electronics is/are shut down. As a result of this, however, it is no longer possible for vehicle-based systems to detect a danger to living beings who are located in the vehicle interior when the vehicle is stationary. Disclosure of the invention

It is an object of the present disclosure to provide a system for monitoring the interior of a vehicle, a vehicle having such a system, a method for monitoring the interior of a vehicle and a storage medium for executing the method, which can avoid a danger to living beings in a vehicle. In particular, it is an object of the present disclosure to avoid the danger to living beings in the interior of the vehicle, for example while the vehicle is in an idle mode.

This object is achieved by the subject matter of the independent claims. Advantageous configurations are specified in the dependent claims.

According to one independent aspect of the present disclosure, a system for monitoring the interior of a vehicle, in particular of a motor vehicle, is specified. The system comprises a detection unit which is configured to detect living beings in an interior of the vehicle; and at least one control unit, wherein the control unit is configured to actuate at least one vehicle function in order to influence at least one environmental condition in the interior of the vehicle if:
(i) the detection unit detects a living being in the interior of the vehicle, and
(ii) the at least one environmental condition in the interior of the vehicle exceeds or falls below at least one predetermined threshold value;
and/or wherein the control unit is configured to actuate at least one vehicle function in order to influence at least one environmental condition in the interior of the vehicle if:
(i) the detection unit detects a living being in the interior of the vehicle, and
(ii) the at least one environmental condition in the interior of the vehicle exhibits a rise or fall.

The detection unit is preferably configured to detect living beings in the interior of the vehicle if the vehicle is in a parked state, wherein the at least one control unit is further configured to actuate the at least one vehicle function in order to influence at least one environmental condition in the interior of the vehicle when the respective further conditions (i) and (ii) mentioned above are present if: (iii) the vehicle is in the parked state.

The conditions (i), (ii) and (iii) can be checked for at least partially simultaneously or sequentially. For example, according to one embodiment, with regard to the condition (ii), the at least one environmental condition can be monitored continuously, whereas the conditions (i) and (iii) are checked for only if the at least one predetermined (first) threshold value has been reached (or will soon be reached) and/or if the rise or fall has been detected. According to an alternative embodiment, provision can be made e.g. for the condition (ii) to be checked for only when the conditions (i) and (iii) are present, i.e. if a living being has been detected in the interior of the vehicle and the vehicle is parked.

According to one embodiment, provision can also be made for the above-mentioned possible conditions (ii) for influencing the environmental condition to have to be additionally present, i.e. for the control unit to be able to be configured to actuate at least one vehicle function in order to influence at least one environmental condition in the interior of the vehicle if:
(i) the detection unit detects a living being in the interior of the vehicle, and
(ii) the at least one environmental condition in the interior of the vehicle exceeds or falls below at least one predetermined threshold value and the at least one environmental condition in the interior of the vehicle exhibits a rise or fall.

According to the invention, energy-consumption-optimized monitoring of the interior can take place, for example while the vehicle is stationary. This can e.g. in particular be achieved as a result of only living beings and the at least one environmental condition being detected. If the environmental conditions lie in a range that is dangerous for living beings, suitable measures can be taken automatically. For example, windows can be opened and/or an air-conditioning system can be turned on if the temperature in the interior of the vehicle exceeds a certain threshold. Similarly, windows can be closed and/or a heating system can be activated if the temperature in the interior of the vehicle falls below a certain threshold. As a result of this, a danger to the health of living beings can be avoided, in particular even while the vehicle is stationary.

The term “living being”, as used in the context of the present disclosure, refers to humans and animals. In particular, the term “living being” refers to occupants of the vehicle.

The terms “parked” and “parked state”, as used in the context of the present disclosure, can refer, according to some embodiments, to a vehicle state in which the vehicle is in a defined idle mode. The idle mode can in this case be an energy-saving mode, which can also be referred to as a degraded mode. In particular, after a vehicle has been parked, the vehicle or the electronics thereof is/are generally shut down and passes/pass into the defined idle mode. The idle mode can in this case be defined individually for different vehicle types and/or vehicle manufacturers.

For example, in accordance with the present invention, the idle mode can be left or modified (in order to allow the environmental condition to be influenced) if the detection unit has detected a living being in the interior of the vehicle.

The present disclosure is not limited to the parked state, however, and the inventive monitoring and actuating in order to produce improved environmental conditions can also take place during operation (e.g. during a journey) of the vehicle.

The at least one environmental condition is preferably selected from the group comprising, or consisting of, a temperature (heat or cold), an incidence of light, an oxygen content and a carbon dioxide content. The present disclosure is not limited to this, however, and can comprise other environmental conditions which influence a living being or the health of a living being.

The at least one control unit is preferably configured to monitor the rise or fall of the at least one environmental condition and to determine a time at which the at least one environmental condition exceeds or falls below, or will in the foreseeable future exceed or fall below, the at least one predetermined threshold value. In particular, a drop or rise in at least one environmental condition can be detected and the time until it reaches the threshold value can be estimated. In other words, e.g. measurement values relating to the environmental condition can be extrapolated into the future and compared with a threshold value.

In some embodiments, when the rise or fall is detected, the vehicle can be set to an increased sensitivity and/or can independently be woken from the idle state. Typically, the detecting of the parked state and/or the detecting of the living being in the interior of the vehicle only takes place if the rise or fall has been detected.

The system preferably comprises at least one sensor which is configured to detect the at least one environmental condition. For example, the system comprises at least one temperature sensor for detecting an interior temperature and/or an exterior temperature. In addition or alternatively, the system can comprise at least one light sensor for detecting an incidence of light, e.g. in the interior of the vehicle. An energy which is applied to the vehicle and/or the interior can be derived from the incidence of light. In addition or alternatively, the system can comprise at least one oxygen sensor for detecting the oxygen content in the interior of the vehicle. In addition or alternatively, the system can comprise at least one CO2 sensor for detecting the CO2 content in the interior of the vehicle. In addition or alternatively, the system can comprise at least one moisture sensor for detecting or deriving a moisture content in the interior of the vehicle.

The at least one sensor can be integrated in the detection unit, for example. Alternatively, the at least one sensor can be provided separately from the detection unit.

The at least one vehicle function is actuated if the at least one environmental condition in the interior of the vehicle exceeds or falls below at least one predetermined threshold value or lies or will lie outside of a normal range. At least one corresponding threshold value and/or normal range can be set individually for each environmental condition. In addition or alternatively, the at least one vehicle function is actuated if the at last one environmental condition rises or falls. In particular, a gradient can be ascertained over time. The at least one vehicle function can be actuated based on the gradient, and in particular based on when the at least one environmental condition reaches a critical level or the at least one (first) threshold value.

In some embodiments of the present disclosure, which can be combined with other embodiments described here, the at least one predetermined threshold value can be a single threshold value. In particular, the at least one vehicle function can be actuated if the at least one environmental condition in the interior of the vehicle (a) is equal to or greater than or (b) is equal to or less than the predetermined threshold value. For example, an air-conditioning system of the vehicle can be activated at a temperature of 30° C. or more in order to cool the interior. Similarly, a heating system of the vehicle can be activated at a temperature of 15° C. or less in order to heat the interior.

In some embodiments of the present disclosure, which can be combined with other embodiments described here, the at least one predetermined threshold value can comprise two threshold values or be two threshold values. In particular, the at least one vehicle function can be actuated if the at least one environmental condition in the interior of the vehicle lies outside of a range defined by a first (upper) threshold value and a second (lower) threshold value. Such a range can be referred to as “normal range”.

The normal range can in this case be set suitably and individually for each environmental condition. For example, corresponding normal ranges can be set for the temperature, the incidence of light, the oxygen content and/or the carbon dioxide content. In some embodiments, the normal range is defined by the first (upper) threshold value and the second (lower) threshold value (e.g. temperature in a range from 15° C. to 30° C.).

The detection unit is preferably configured to detect species of living beings. In particular, the detection unit can be configured to detect humans and animals and to distinguish between them. In addition or alternatively, the detection unit can be configured to detect an identity of people. For example, person-specific threshold values can be set and used for the environmental conditions.

In some embodiments of the present disclosure, which can be combined with other embodiments described here, the at least one predetermined threshold value can be global, i.e. the at least one predetermined threshold value can be applied equally to all living beings. For example, the normal range for a temperature can be defined in the range from 15° C. to 30° C. If the interior temperature lies outside of this range, suitable measures can be taken regardless of the detected life form. For example, an air-conditioning system of the vehicle can be activated at a temperature of more than 30° C. in order to cool the interior for the detected living being. Similarly, a heating system of the vehicle can be activated at a temperature of less than 15° C. in order to heat the interior for the detected living being.

In further embodiments of the present disclosure, which can be combined with other embodiments described here, the at least one predetermined threshold value can be defined individually for living beings. For example, the normal range for a human can be in the range from 15° C. to 30° C., and the normal range for a dog can be in the range from 5° C. to 35° C. If the interior temperature lies outside of this range, suitable measures can be taken depending on the species of the life form (e.g. human or dog) detected in the interior. Optionally, air circulation in the interior of the vehicle can also be ensured in order to produce environmental conditions which are more hospitable.

If two species of living beings are detected in the interior of the vehicle, prioritization can take place. If, for example, a human and a dog are detected, priority can be given to the human. The actuation of the at least one vehicle function then conforms to the at least one threshold value applicable to the human.

The at least one vehicle function is preferably selected from the group comprising, or consisting of, a cooling function (e.g. air-conditioning system), a heating function (e.g. heating system, seat heating system, neck-level heating system, etc.), a sunroof function (e.g. opening or closing the sunroof), a window function (e.g. opening or closing at least one window), a door function (e.g. opening or closing at least one door and/or a trunk) and a shading function (e.g. sunshade on the windows and/or sunroofs).

The detection unit is preferably configured to detect both living beings and the at least one environmental condition in the interior of the vehicle. In particular, a single unit can be used to detect both aspects. As a result, energy consumption, in particular in the idle mode of the vehicle, can be reduced since two separate units do not have to be operated, for example, in order to detect the living being and the at least one environmental condition.

The detection unit preferably comprises, or is, at least one camera, and in particular at least one interior camera.

The detection unit, such as e.g. the at least one camera, preferably comprises at least one integrated sensor which is configured to detect the at least one environmental condition. For example, the at least one camera comprises at least one integrated temperature sensor.

The detection unit preferably comprises at least one moisture sensor for detecting or deriving a moisture content in the interior of the vehicle. In particular, a rise in the humidity caused by exhaled air can be an indicator that a living being is in the vehicle. In addition or alternatively, the detection unit can be configured to determine fogging of vehicle windows. Such a detection is possible, for example, by way of a rain/light/solar/fogging sensor module on the rear side of the interior mirror.

The at least one integrated sensor is preferably a sensor provided for the operation of the detection unit, such as, for example, a temperature sensor for detecting an operating temperature of the camera. This sensor can additionally be used to detect the at least one environmental condition, such that no additional sensor has to be provided for this task.

The detection unit preferably comprises (or is) a thermal imaging camera. In some embodiments, the thermal imaging camera can fulfill a dual function, namely the detection of the vehicle occupants and the detection of the at least one environmental condition, and in particular of an interior temperature. For example, the thermal imaging camera can detect a temperature of one or more surfaces (e.g. steering wheel, dashboard, etc.), from which conclusions can be drawn about the interior temperature.

The detection unit is, however, not limited to the above-mentioned examples and can comprise other suitable means for detecting the at least one living being, such as, for example, at least one seat occupancy sensor and/or at least one microphone (e.g. interior microphone). In some embodiments, two or more detection units of different types can be used in order to detect the living beings in the interior of the vehicle. In particular, a plurality of detection units can be interconnected in order to improve detection accuracy.

The detection unit is preferably configured to detect and/or determine a position of a living being in the interior of the vehicle. In some embodiments, the at least one vehicle function can be actuated based on the position of the detected living being. If, for example, a person is detected on the left rear seat, the left rear window can be opened in the case of a high temperature in the interior. In addition or alternatively, an air-conditioning system of the vehicle can be actuated locally.

The system preferably comprises a vehicle-state detection unit which is configured to detect the parked state of the vehicle. The vehicle-state detection unit can detect, for example, that the vehicle is in the idle mode and conclude from this that the vehicle has been parked. In addition or alternatively, the parked state can be inferred from at least one further aspect, such as, for example, a position of the vehicle (e.g. garage), the engine being switched off, the driver getting out of the vehicle, etc.

The vehicle-state detection unit is preferably configured to detect a battery state-of-charge and/or a tank content of the vehicle. The vehicle-state detection unit can communicate information regarding diminishing energy reserves to the at least one control unit of the system according to the invention (in the parked state and if a living being is detected). For example, the vehicle-state detection unit can communicate to the at least one control unit that the energy reserves will be depleted at a specific time x. A remaining running time of the life-sustaining measures can thus be estimated. In some embodiments, the system according to the invention can, by means of an emergency-call function, make an emergency call in a predetermined period of time (e.g. y minutes) before the specific time x is reached.

According to a further independent aspect of the present disclosure, a vehicle, in particular a motor vehicle, is specified. The vehicle comprises the system for monitoring the interior of a vehicle according to the embodiments of the present disclosure.

The term vehicle comprises passenger cars, trucks, buses, motorhomes, motorcycles, etc. used for transporting people, goods, etc. The term in particular comprises motor vehicles for passenger transport.

According to a further independent aspect of the present disclosure, a method for monitoring the interior of a vehicle, in particular of a motor vehicle, is specified. The method comprises detecting, e.g. while the vehicle is in a parked state, whether at least one occupant is located in an interior of the vehicle; and detecting at least one environmental condition in the interior of the vehicle. The method further comprises at least one of the following steps: (a) actuating at least one vehicle function in order to influence the at least one environmental condition if a living being is located in the interior of the vehicle and the at least one environmental condition exceeds or falls below at least one predetermined threshold value; (b) actuating at least one vehicle function in order to influence the at least one environmental condition if a living being is located in the interior of the vehicle and the at least one environmental condition exhibits a rise or fall.

The method for monitoring the interior of a vehicle can implement the aspects of the system for monitoring the interior of a vehicle described in this document.

According to a further independent aspect of the present disclosure, a software (SW) program is specified. The software program can be configured to be executed on one or more processors, and as a result to execute the method for monitoring the interior of a vehicle described in this document.

According to a further independent aspect of the present disclosure, a storage medium is specified. The storage medium can comprise a SW program which is configured to be executed on one or more processors, and as a result to execute the method for monitoring the interior of a vehicle described in this document.

According to a further independent aspect of the present disclosure, software having program code for carrying out the method for monitoring the interior of a vehicle is to be executed if the software runs on one or more software-controlled devices or processors.

A processor is a programmable arithmetic-logic unit, that is to say a machine or an electronic circuit, which controls other elements according to transferred commands and in so doing initiates an algorithm (process).

Exemplary embodiments of the disclosure are illustrated in the figures and are described in more detail hereinbelow.

### BRIEF DESCRIPTION OF THE DRAWINGS

FIG. 1 schematically shows a vehicle having a system for monitoring the interior of a vehicle according to exemplary embodiments of the present disclosure; and

FIG. 2 is a flowchart of a method for monitoring the interior of a vehicle according to exemplary embodiments of the present disclosure.

Hereinbelow, the same reference signs are used for identical and identically acting elements unless stated otherwise.

### DETAILED DESCRIPTION OF THE DRAWINGS

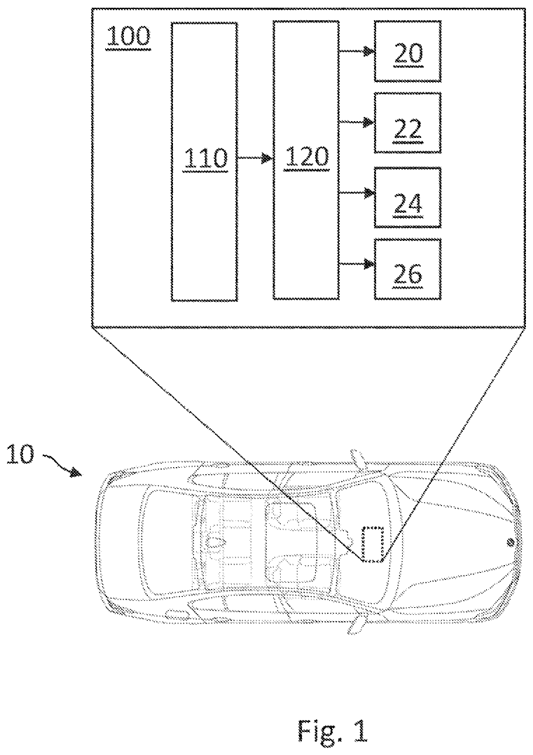

FIG. 1 schematically shows a vehicle 10 having a system 100 for monitoring the interior of the vehicle 10 according to embodiments of the present disclosure. In some embodiments, the vehicle can be a parked vehicle.

The system 100 comprises a detection unit 110 which is configured to detect living beings in an interior of the vehicle 10, for example if the vehicle 10 is in a parked state; and at least one control unit 120 which is configured to actuate at least one vehicle function 20, 22, 24, 26 in order to influence or change at least one environmental condition in the interior of the vehicle 10 if:
(i) the detection unit 110 detects a living being, such as e.g. an occupant, in the interior of the vehicle 10, and
(ii) the at least one environmental condition in the interior of the vehicle 10 exceeds or falls below at least one predetermined threshold value or lies outside of a normal range, and/or if the at least one environmental condition exhibits a rise or fall.

The at least one vehicle function 20, 22, 24, 26 can be, for example, a cooling function 20 (e.g. an air-conditioning system), a heating function 22 (e.g. a heating system, seat heating system, neck-level heating system, etc.), a sunroof function 24 (e.g. for opening or closing the sunroof) or a window function 26 (e.g. for opening or closing at least one window).

In one exemplary embodiment, vehicle-based sensors can be temporarily used during the “parked” state in order to detect, based on cameras by way of object detection and/or based on sound by way of characteristic sound detection, whether living beings are located in the vehicle interior. The present disclosure is, however, not limited to camera-based detection and a gas measurement (oxygen, carbon), a measurement of a humidity, etc. can, for example, be implemented.

At the same time, for example, the interior temperature (and optionally the exterior temperature) can be measured in order to decide whether the vehicle interior temperature is inhospitable. Measuring the interior temperature can, for example, be carried out and/or verified by the camera(s) for the object detection. For this purpose, a temperature sensor of the image sensor can be used, for example. In addition or alternatively, high interior temperatures can be inferred from noise in the camera image.

If environmental conditions that are inhospitable for the occupant are detected in the vehicle interior, the vehicle air-conditioning system can regulate the passenger interior to a minimum vital and/or comfortable temperature, in particular depending on a battery state-of-charge of the vehicle. This can also degrade from a comfortable temperature to a minimum vital temperature the nearer a depletion of energy reserves of the vehicle approaches.

In a further example, a CO2 sensor system can ensure activation of the vehicle air-conditioning system regardless of the exterior and interior temperature in the vehicle interior when a trigger (e.g. sound and/or object) is detected. Here, in some embodiments, windows and/or sunroofs can be opened in order to ensure a suitable 02 concentration as quickly as possible.

In yet a further example, a light sensor, which can measure the energy (e.g. watt per square meter) radiated from the sun onto the vehicle and/or the interior, can be used to activate the vehicle air-conditioning system.

If, for example, a baby, small child or pet is now located in the vehicle while the parents or the pet owner have left the vehicle and do not return to the vehicle for a relatively long duration during which the environmental conditions in the vehicle interior deteriorate, the vehicle air-conditioning system can be activated. For example, the interior temperature can be reduced such that there is no danger to the vehicle occupants.

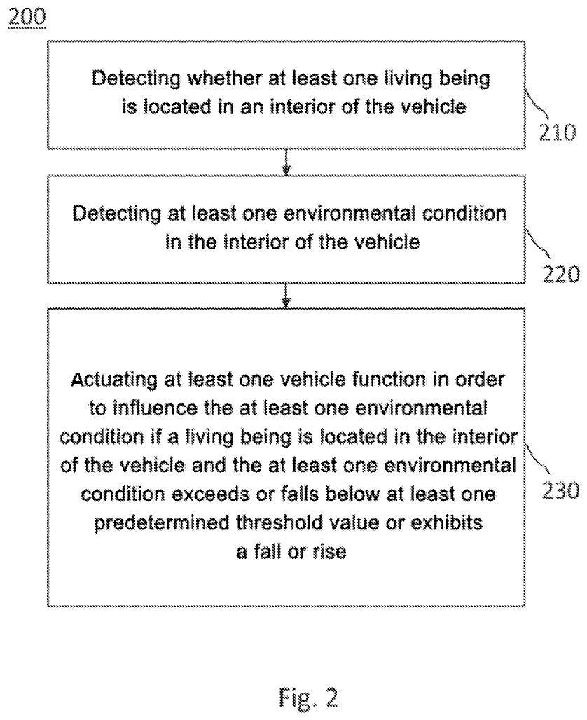

FIG. 2 schematically shows a flowchart of a method 200 for monitoring the interior of a vehicle according to embodiments of the present disclosure.

The method 200 can be implemented by corresponding software which is able to be executed by one or more processors (e.g. a CPU).

The method 200 comprises in block 210 detecting whether at least one occupant is located in an interior of the vehicle; in block 220 detecting at least one environmental condition in the interior of the vehicle; and in block 230 actuating at least one vehicle function in order to influence or change the at least one environmental condition if an occupant is located in the interior of the vehicle and the at least one environmental condition exceeds or falls below at least one predetermined threshold value or lies outside of a normal range.

According to the invention, energy-consumption-optimized monitoring of the interior takes place, for example while the vehicle is stationary. This is in particular achieved as a result of only living beings and the at least one environmental condition being detected. If the environmental conditions lie in a range that is dangerous for living beings, suitable measures can be taken automatically. For example, windows can be opened and/or an air-conditioning system can be switched on if the temperature in the interior of the vehicle exceeds a certain threshold. Similarly, windows can be closed and/or a heating system can be activated if the temperature in the interior of the vehicle falls below a certain threshold. As a result, a danger to the health of occupants can be avoided, in particular even while the vehicle is stationary.

Although the invention has been explained and illustrated more specifically in detail by preferred exemplary embodiments, the invention is not limited by the disclosed examples and other variations can be derived therefrom by a person skilled in the art without departing from the protective scope of the invention. It is therefore clear that there are a multiplicity of possible variations. It is likewise clear that embodiments mentioned by way of example actually only illustrate examples which are in no way to be interpreted as a limitation of the protective scope, of the possible applications or of the configuration of the invention, for instance. Rather, the preceding description and the description of the figures enable a person skilled in the art to specifically implement the exemplary embodiments, wherein a person skilled in the art with knowledge of the disclosed concept of the invention can make various changes, for example in terms of the function or the arrangement of individual elements mentioned in an exemplary embodiment, without departing from the protective scope which is defined by the claims and the legal equivalents thereof, such as more in-depth explanations in the description, for instance.

1. to 11. (canceled)

12. A system for monitoring an interior of a vehicle, comprising:
a detection unit which is configured to detect living beings in the interior of the vehicle; and
at least one control unit,
wherein the control unit is configured to actuate at least one vehicle function in order to influence at least one environmental condition in the interior of the vehicle in response to:
(i) the detection unit detecting a living being in the interior of the vehicle, and
(ii) the at least one environmental condition in the interior of the vehicle exceeding or falling below at least one predetermined threshold value; and/or
wherein the control unit is configured to actuate at least one vehicle function in order to influence at least one environmental condition in the interior of the vehicle in response to:
(i) the detection unit detecting a living being in the interior of the vehicle, and
(iii) the at least one environmental condition in the interior of the vehicle exhibiting a rise or fall.

13. The system according to claim 12, wherein
the detection unit is further configured to detect living beings in the interior of the vehicle when the vehicle is in a parked state, and
the control unit is further configured to actuate the at least one vehicle function in order to influence at least one environmental condition in the interior of the vehicle when conditions (i) and (ii) and/or (i) and (iii) are present if:
(iv) the vehicle is in the parked state.

14. The system according to claim 12, wherein
the at least one environmental condition is selected from the group comprising: a temperature, an incidence of light, an oxygen content, and a carbon dioxide content.

15. The system according to claim 14, wherein
the at least one vehicle function is selected from the group comprising: a cooling function, a heating function, a sunroof function, a window function, a door function, and a shading function.

16. The system according to claim 12, wherein
the at least one vehicle function is selected from the group comprising: a cooling function, a heating function, a sunroof function, a window function, a door function, and a shading function.

17. The system according to claim 12, wherein
the control unit is configured to monitor the rise or fall of the at least one environmental condition and to determine a time at which the at least one environmental condition exceeds or falls below, or will exceed or fall below, the at least one predetermined threshold value.

18. The system according to claim 12, wherein
the detection unit is configured to detect both living beings and the at least one environmental condition in the interior of the vehicle.

19. The system according to claim 12, wherein
the detection unit comprises at least one camera, and
the at least one camera comprises an integrated temperature sensor.

20. The system according to claim 12, wherein
the detection unit comprises at least one of: a thermal imaging camera, a microphone, or a seat occupancy sensor.

21. The system according to claim 12, wherein
the detection unit is configured to determine a position of a living being in the interior of the vehicle, and
the control unit is configured to actuate the at least one vehicle function based on the detected position.

22. A method for monitoring an interior of a vehicle, comprising:
detecting whether at least one living being is located in the interior of the vehicle; and
detecting at least one environmental condition in the interior of the vehicle;
wherein the method further comprises at least one of the following steps:
(a) actuating at least one vehicle function in order to influence the at least one environmental condition in response to a living being being located in the interior of the vehicle and the at least one environmental condition exceeding or falling below at least one predetermined threshold value; or (b) actuating at least one vehicle function in order to influence the at least one environmental condition in response to a living being being located in the interior of the vehicle and the at least one environmental condition exhibiting a rise or fall.

23. A computer product comprising a non-transitory computer-readable medium having stored thereon program code which, when executed on one or more processors, carries out the acts of:
actuating at least one vehicle function in order to influence at least one environmental condition in an interior of a vehicle in response to:
(i) detecting a living being in the interior of the vehicle, and
(ii) the at least one environmental condition in the interior of the vehicle exceeding or falling below at least one predetermined threshold value; and/or
actuating at least one vehicle function in order to influence at least one environmental condition in the interior of the vehicle in response to:
(i) detecting a living being in the interior of the vehicle, and
(iii) the at least one environmental condition in the interior of the vehicle exhibiting a rise or fall.
